(19) United States
(12) Patent Application Publication
(10) Pub. No.: US 2009/0084998 A1
(43) Pub. Date: Apr. 2, 2009

(54) Noise attenuation valve assembly

(76) Inventors: Joseph Callahan, Greenwood, IN (US); Ivan Arbuckle, Columbus, IN (US); Kwin Abram, Columbus, IN (US)

Correspondence Address: PAMELA A. KACHUR, 950 W 450 S, BLDG. 4, COLUMBUS, IN, 47201, US

(21) Appl. No.: 11/660,628

(22) PCT Filed: Sep. 8, 2005
(86) PCT No.: PCT/US2005/032194

§ 371 Date: Feb. 20, 2007

Related U.S. Application Data
(60) Provisional application No. 60/612,032, filed on Sep. 22, 2004.

(51) Int. Cl. F16K 31/10; F16K 31/52; G05G 5/04; F01N 7/00

(52) U.S. Cl. 251/129.2; 251/231; 60/324

(57) ABSTRACT

A control mechanism for a noise attenuation valve in a vehicle exhaust system is configured to significantly reduce operational noises. The noise attenuation valve includes a flapper valve (18) that is supported on a shaft (16) for rotation within an inlet tube (14). The shaft is coupled to an actuator (27) with a linkage assembly (30). The linkage assembly (30) includes a lever (42) that contacts noise attenuation pads (48) at maximum travel limits defined by a backing plate (46) to reduce operational noise. In one example configuration, the actuator provides a bottomless solenoid configuration and utilizes a pulse width modulation control module to further reduce operational noises.

### RELATED APPLICATIONS

The application claims priority to U.S. Provisional Application No. 60/612,032, which was filed on Sep. 22, 2004.

### BACKGROUND OF THE INVENTION

The subject invention relates to a control mechanism for a noise attenuation valve in a vehicle exhaust system that that significantly reduces operational noises.

Noise attenuation valves are often used in vehicle exhaust systems to reduce noise generated during vehicle operation. In one example, a noise attenuation valve is incorporated into a muffler to reduce noise generated by a vehicle engine.

Traditionally, the noise attenuation valve includes a flapper valve mounted on a shaft that pivots the flapper valve within an inlet tube formed within the muffler. The inlet tube defines an open passage through which exhaust gases flow. The flapper valve has a disc shaped body that rotates within the inlet tube to vary exhaust gas flow area. The shaft is coupled to a solenoid with a linkage assembly. A controller controls the solenoid to rotate the shaft via the linkage assembly. As the shaft rotates, the flapper valve varies the exhaust gas flow area as needed to attenuate noise.

One disadvantage with this traditional configuration is that components in the noise attenuation valve and solenoid generate operational noise. For example, movement of the linkage assembly and rotation of the shaft can generate noises due to slack and clearance between the components. Additionally, operational movement of the solenoid generates undesired noise. For example, the solenoid includes a plunger that is coupled to the linkage assembly and during operation, the plunger can bottom out within the solenoid, which generates noise.

Thus, it is desirable to provide a control mechanism for a noise attenuation valve that reduces operational noises.

### SUMMARY OF THE INVENTION

A control mechanism for a noise attenuation valve in a vehicle exhaust system is uniquely configured to reduce operational noises during valve actuation. The noise attenuation valve includes a flapper valve that is supported on a shaft for rotation within an inlet tube. The shaft is coupled to an actuator with a linkage assembly. The linkage assembly includes a lever that contacts noise attenuation pads at maximum travel limits defined by a backing plate, and reducing operational noise.

In one example configuration, the actuator comprises a solenoid having a bottomless solenoid configuration. The solenoid includes a plunger that is coupled to the shaft with the linkage assembly. The solenoid has a body with an internal cavity defining an end face. The plunger moves into a fully retracted position within the internal cavity without contacting the end face to provide the bottomless solenoid configuration. By avoiding contact with the end face, operational noise is reduced.

In one example configuration, the control mechanism utilizes a pulse width modulation control module to further reduce operational noises. The pulse width modulation control module shapes current to precisely control actuation of the solenoid as the plunger reaches end of travel positions.

These and other features of the present invention can be best understood from the following specification and drawings, the following of which is a brief description.

### BRIEF DESCRIPTION OF THE DRAWINGS

FIG. 1 is a perspective view of an exhaust component incorporating the subject invention.

FIG. 2 is a side view of the exhaust component of FIG. 1.

FIG. 3 is a perspective view of one example of an exhaust component with a noise attenuation valve assembly control mechanism incorporating the subject invention.

FIG. 4A is a schematic side view of another example of a control mechanism incorporating the subject invention in a first position.

FIG. 4B is a schematic side view the control mechanism of FIG. 4A in a second position.

FIG. 4C is a schematic side view the control mechanism of FIG. 4A in a third position.

FIG. 5 is a perspective view of a control mechanism with a pulse width modulation control module.

### DETAILED DESCRIPTION OF THE PREFERRED EMBODIMENTS

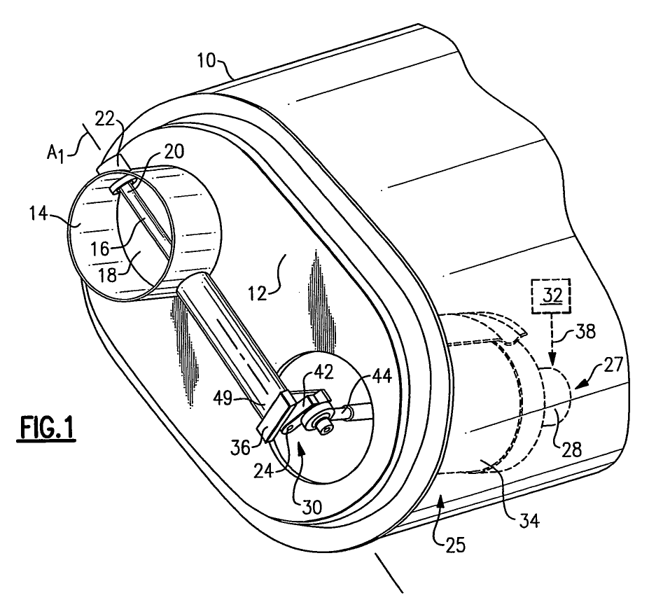

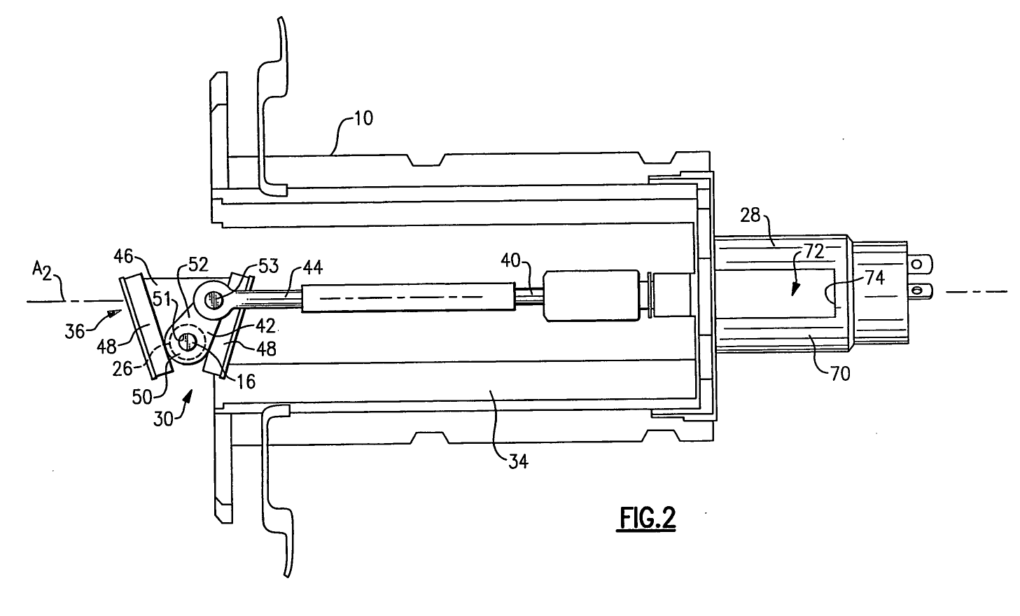

As shown in FIG. 1, a muffler 10 includes a datum plate 12 that supports an inlet tube 14 that receives exhaust gases. A noise attenuation valve assembly includes a shaft 16 and a flapper valve 18 that is fixed to the shaft 16. The shaft 16 has a first shaft end 20 supported in a first bushing 22 and a second shaft end 24 supported in a second bushing 26 (FIG. 2). The shaft 16 rotates within the first 22 and second 26 bushings about an axis A1 to move the flapper valve 18 within the inlet tube 14 to vary exhaust gas flow area.

As shown in FIG. 1, the shaft 16 is driven by a control mechanism 25 to control the position of the flapper valve 18 within the inlet tube 14. The control mechanism 25 includes an actuator 27 and a linkage assembly 30 that couples the shaft 16 to the actuator 27. In the example shown, the actuator 27 is a solenoid 28. A controller 32 controls the solenoid 28 to rotate the shaft 16 via the linkage assembly 30. In one example, the controller 32 comprises an engine management system, which generates a control signal 38 to control actuation of the solenoid 28. The solenoid 28 rotates the shaft 16, which changes the position of the flapper valve 18 to vary the exhaust gas flow area as needed to attenuate noise.

A support tube 34 is mounted to the datum plate 12. The solenoid 28 is attached to the support tube 34. As shown in FIG. 2, the solenoid 28 includes a plunger 40 that is coupled to the linkage assembly 30. The plunger 40 moves in a linear direction along an axis A2 to rotate the linkage assembly 30. The axis A2 is positioned transversely relative to axis A1 defined by the shaft 16 and does not intersect axis A1. The linkage stop 36 limits the rotational actuation range of the linkage assembly 30. As discussed above, the linkage assembly 30 rotates the shaft 16 to control movement of the flapper valve 18 to attenuate noise. The operation of the controller 32, solenoid 28, and flapper valve 18 to control noise is known and will not be discussed in further detail.

The linkage assembly 30 includes a lever 42 that has one end mounted adjacent to the second shaft end 24 of shaft 16. An additional linkage member 44 connects the lever 42 to the plunger 40. The plunger 40 moves the additional linkage member 44 along the axis A2, which causes lever 42 to rotate about axis A1.

The linkage stop 36 comprises a backing plate 46 and a pair of noise attenuation pads 48. The backing plate 46 is mounted to a non-rotating exhaust component such as a tube portion 49 that extends from the inlet tube 14 toward the linkage assembly 30. The tube portion 49 surrounds the shaft 16 and supports the second bushing 26.

The noise attenuation pads 48 cooperate with the lever 42 to reduce operational noise as the lever 42 moves between first and second valve positions. The noise attenuation pads 48 define the maximum amount of travel for the lever 42 in two (2) opposing directions as the lever 42 moves back and forth between the first and second valve positions. The first and second valve positions are preferably fully open and fully closed positions, however, the first and second valve positions could also correspond to partially open and/or partially closed positions depending on application requirements.

The lever 42 includes a first portion 50 with an opening 51 that receives the shaft 16, and a second portion 52 that includes an extension portion 53 that is coupled to the additional linkage member 44. The first portion 50 of the lever 42 is always in contact with the noise attenuation pads 48. The second portion 52 of the lever 42 is moved into engagement with one of the noise attenuation pads 48 in the first valve position and is then moved into engagement with the other of the noise attenuation pads 48 in the second valve position.

In one example, the noise attenuation pad 48 is made from a wire mesh material, however, other known materials could also be used. Also, while two (2) noise attenuation pads 48 are shown, it should be understood that only one (1) noise attenuation pad 48 may be required to sufficiently reduce noise. By providing a linkage stop 36 with noise attenuation pads that engage an actuation lever 42 to define a maximum amount of travel for the lever 42, operational noises are significantly reduced.

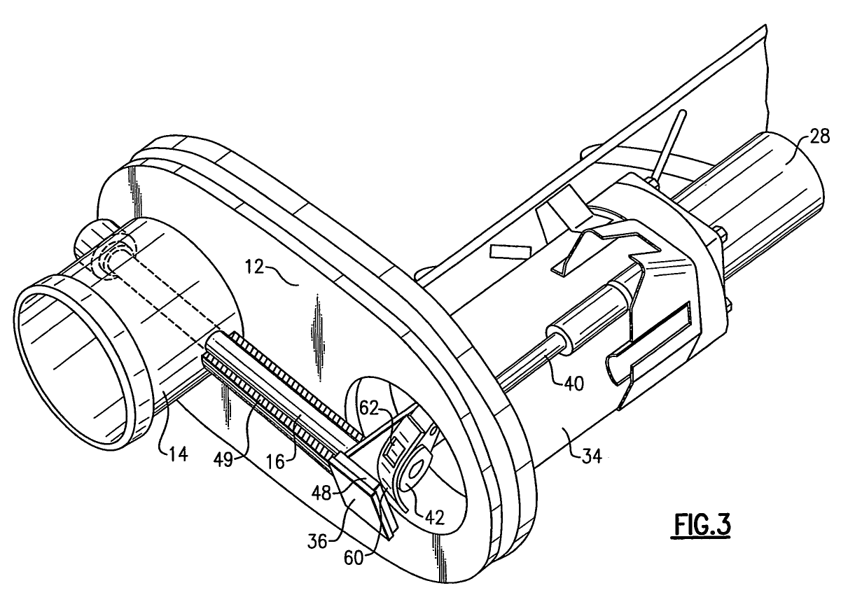

In one example, shown in FIG. 3, the lever 42 includes a portion 60 that is formed about at least a portion of an outer perimeter of the lever 42. In the example shown in FIG. 3, the portion 60 is formed with a rectangular shape having an opening 62. The portion 60 is positioned between the lever 42 and the noise attenuation pad 48. The portion 60 is preferably integrally formed with the lever 42 as one piece but could be formed as a separate piece that is attached to the lever.

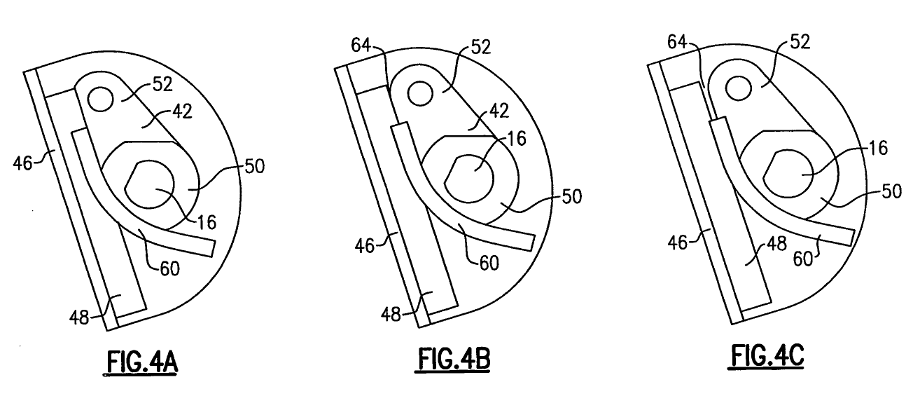

In another example shown in FIGS. 4A-C, the portion 60 has a curved surface S that is formed at least partially about the outer perimeter of the lever 42. FIG. 4A shows a configuration where the portion 60 is positioned relative to the noise attenuation pad 48 such that the first portion 50 rests directly against the noise attenuation pad 48. The curved surface S can be shifted to help separate the first portion 50 of the lever 42 from the noise attenuation pad 48 to form a gap 64, as shown in FIGS. 4B and 4C. The curved surface S is shifted further away from the noise attenuation pad 48 in FIG. 4C than in FIG. 4B. The gap 64 is at least partially retained as the lever 42 rotates between the first and second valve positions. The curved surface S cooperates with the lever 42 and the noise attenuation pad 48 to further reduce operational noises.

The control mechanism 25 also includes other components that further reduce operational noises. As shown in FIG. 2, the solenoid 28 includes a body 70 with an internal cavity 72 having an end face 74. In this example, the solenoid 28 is a “bottomless” solenoid where the plunger 40 is prevented from contacting the end face 74 in the body 70 when the plunger 40 is fully retracted into the body 70 by having an end of travel limit position spaced from the end face 74. This eliminates noise that is traditionally generated by the plunger bottoming out within the solenoid by contacting the end face 64.

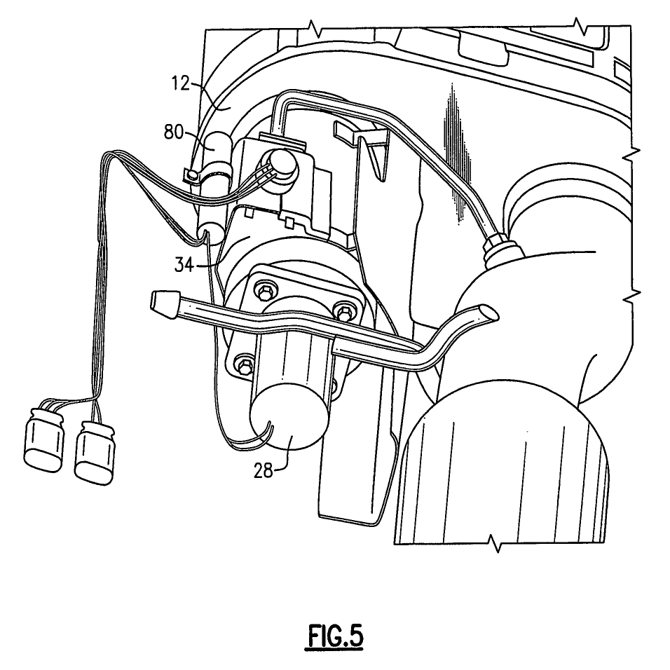

Operational noises are further reduced by utilizing a pulse width modulation control module 80 as shown in FIG. 5. The pulse width modulation control module 80 shapes current to control actuation of the solenoid 28. Using pulse width modulation control in a noise attenuation valve assembly further reduces operational noises by providing precise and accurate control of the movement of the lever 42. Pulse width modulation contact is known generally, but has not been applied to control exhaust valves. Thus, a worker in this art would know how to provide pulse width modulation control for the disclosed application.

It should be understood that while the control mechanism 25 for the noise attenuation valve assembly is shown in a muffler, the control mechanism 25 could also be used for noise attenuation valve assemblies in other types of exhaust components.

Although a preferred embodiment of this invention has been disclosed, a worker of ordinary skill in this art would recognize that certain modifications would come within the scope of this invention. For that reason, the following claims should be studied to determine the true scope and content of this invention.

1. A control mechanism for a noise attenuation valve comprising:
an actuator;
a lever operably coupled to said actuator to move between first and second valve positions; and
at least one noise attenuation pad cooperating with said lever to reduce operational noise as said actuator moves said lever between said first and said second valve positions.

2. The control mechanism according to claim 1 including a backing plate supported by a non-rotating exhaust system component wherein said at least one noise attenuation pad is mounted on said backing plate.

3. The control mechanism according to claim 1 wherein said at least one noise attenuation pad comprises a wire mesh pad.

4. The control mechanism according to claim 1 wherein said at least one noise attenuation pad comprises a first noise attenuation pad associated with said first valve position and a second noise attenuation pad associated with said second valve position.

5. The control mechanism according to claim 4 wherein said first noise attenuation pad defines a first maximum travel limit for said lever in a first direction at said first valve position and said second noise attenuation pad defines a second maximum travel limit for said lever in a second direction, opposite said first direction, at said second valve position.

6. The control mechanism according to claim 5 wherein said lever includes a first portion that continuously abuts against said first and second noise attenuation pads as said lever moves between said first and said second maximum travel limits, and a second portion that only abuts against said first noise attenuation pad at said first maximum travel limit and only abuts against said second noise attenuation pad at said second maximum travel limit.

7. The control mechanism according to claim 1 wherein said actuator comprises a solenoid having a plunger operably coupled to said lever.

8. The control mechanism according to claim 7 wherein said solenoid includes a body with an internal cavity having an end face and wherein said plunger moves into a fully retracted position within said internal cavity without contacting said end face to provide a bottomless solenoid configuration.

9. The control mechanism according to claim 1 wherein said lever includes a separating portion positioned directly between said at least one noise attenuation pad and said lever where said separating portion remains in direct contact with said at least one noise attenuation pad as said lever moves between said first and second valve positions.

10. The control mechanism according to claim 1 including a flapper valve body supported on a shaft within an exhaust gas inlet wherein said lever couples said shaft to said actuator and wherein a controller controls said actuator to rotate said lever and said shaft to change a position of said flapper valve body within said exhaust gas inlet to attenuate noise.

11. The control mechanism according to claim 1 including a pulse width modulation control module generating a control signal to reduce valve operational noises by using pulse width modulation to control movement of said actuator.

12. A control mechanism for a noise attenuation valve comprising:
a solenoid having a body defining an inner cavity, said inner cavity having an end surface;
a plunger operably coupled to a noise attenuation valve to attenuate noise within an exhaust component, said plunger being received within said inner cavity and being moveable between fully extended and fully retracted positions wherein said plunger is prevented from contacting said end surface in said fully retracted position by reaching an end of travel limit position spaced from said end surface.

13. The control mechanism according to claim 12 wherein the noise attenuation valve includes a flapper valve body supported on a shaft, said plunger being operably coupled to said shaft with a lever to move said flapper valve body between first and second valve positions.

14. The control mechanism according to claim 13 including at least one noise attenuation pad cooperating with said lever to reduce operational noise as said plunger moves said lever between said first and said second valve positions.

15. The control mechanism according to claim 14 including a backing plate supported by a non-rotating exhaust system component wherein said at least one noise attenuation pad comprises a first noise attenuation pad mounted to said backing plate and associated with said first valve position, and a second noise attenuation pad mounted to said backing plate and associated with said second valve position, and wherein said lever directly engages said first noise attenuation pad at said first valve position to define a first maximum travel limit and said lever directly engages said second noise attenuation pad at said second valve position to define a second maximum travel limit opposite from said first maximum travel limit.

16. The control mechanism according to claim 15 wherein said first and said second noise attenuation pads are comprised of a wire mesh material.

17. The control mechanism according to claim 12 including a pulse width modulation control module generating a control signal to reduce valve operational noises by using pulse width modulation to control movement of said solenoid.

18. A control mechanism for a noise attenuation valve comprising:
an actuator for moving a noise attenuation valve component between open and closed positions; and
a pulse width modulation control module generating a control signal to reduce valve operational noises by using pulse width modulation to control movement of said actuator.

19. The control mechanism according to claim 18 wherein said actuator comprises a solenoid having a plunger coupled to said noise attenuation valve component with a linkage assembly and including at least one noise attenuation pad that engages at least a portion of said linkage assembly to reduce operational noises as said noise attenuation valve component moves between said open and closed positions.

20. The control mechanism according to claim 18 wherein said solenoid includes a body with an internal cavity having an end face and wherein said plunger moves into a fully retracted position within said internal cavity without contacting said end face to provide a bottomless solenoid configuration.
